(19) United States
(12) Patent Application Publication
(10) Pub. No.: US 2003/0231698 A1
(43) Pub. Date: Dec. 18, 2003

(54) Apparatus and method for fabricating a semiconductor device and a heat treatment apparatus

(76) Inventors: Takatomo Yamaguchi, Tokyo (JP); Toshimitsu Miyata, Tokyo (JP); Kazuhiko Kudo, Sapporo-city (JP); Yukio Hishinuma, Sapporo-city (JP)

Correspondence Address: BACON & THOMAS, PLLC, 625 SLATERS LANE, FOURTH FLOOR, ALEXANDRIA, VA, 22314

(21) Appl. No.: 10/390,041

(22) Filed: Mar. 18, 2003

(30) Foreign Application Priority Data
Mar. 29, 2002 (JP) 2002-096712

(51) Int. Cl. G01K 7/00

(52) U.S. Cl. 374/179

(57) ABSTRACT

A semiconductor device fabricating apparatus includes a thermocouple and a temperature measuring member. The temperature measuring member has thermal characteristics identical or substantially identical to those of a target substrate, a maximum outer diameter smaller than that thereof, and a thickness identical or substantially identical to that thereof. The thermocouple has a thermal junction point connected to the temperature measuring member. Further, a semiconductor device fabricating method includes loading the target substrate into the reaction chamber, heating the reaction chamber, measuring an inner temperature of the reaction chamber by using a thermocouple and a temperature measuring member, controlling the inner temperature of the reaction chamber based on the temperature measurement, processing the target substrate by supplying process gas into the reaction chamber, to thereby obtain a product substrate, reducing the inner temperature of the reaction chamber, and unloading the product substrate from the reaction chamber.

### FIELD OF THE INVENTION

The present invention relates to a semiconductor device fabricating technique; and, more particularly, to a heat treatment technique performing a heat treatment on a wafer by heating a reaction chamber into which target substrates to be processed are loaded. Such a heat treatment technique is effectively used in designing, e.g., a semiconductor integrated circuit (hereinafter, referred to as an IC) on a semiconductor wafer (hereinafter, referred to as a wafer), wherein the heat treatment technique including an oxidation and diffusion process, a reflow/annealing process for activating carriers and leveling a surface after an ion implantation, a film formation using a thermal CVD(Chemical Vapor Deposition), and the like are carried out in a heat treatment furnace.

### BACKGROUND OF THE INVENTION

A vertical hot-wall type batch heat treatment apparatus (hereinafter, referred to as a hot-wall type heat treatment apparatus) has been widely employed in heat-treating wafers for use in fabricating the IC. The hot-wall type heat treatment apparatus includes a process tube vertically disposed forming a reaction chamber, i.e., an inner tube defining an inner space of a reaction chamber into which the wafers are loaded and an outer tube enclosing the inner tube, and a heater unit provided outside of the reaction chamber, for heating the interior of the process tube. The heat treatment of the wafers vertically stacked in a boat are carried out by heating the reaction chamber by the heater unit, wherein the boat is loaded into the reaction chamber through a furnace mouth formed at the bottom of the inner tube. In such a hot-wall type heat treatment apparatus, profile thermocouples (hereinafter, referred to as thermocouples) are disposed between the process tube and the boat to measure ambient temperatures of the wafers. Based on the measured temperatures, the feedback control is applied to the heater unit, thereby enabling a precise control of the heat treatment.

In such a temperature controlling method, there occurs a difference in temperatures measured by the thermocouples and the actual temperatures of the wafers, since the thermocouples measure the ambient temperatures of the wafers. Further, since the response of the thermocouples is deteriorated when there is a rapid increase or decrease in temperature of the heater unit, the feedback response is delayed, and thereby the feedback control process becomes ineffective.

In order to settle the difference between the actual temperature of the wafers and the temperature measured by the thermocouples, one method is disclosed in Japanese Patent Open-Laid Publication No. 1999-111623. The method suggests connecting temperature measuring portions (thermal junction points) of thermocouples with wafers, mounting the thermocouple-connected wafers in a boat, and loading the boat into a furnace tube.

In such a method for measuring the actual temperatures of the wafers, however, the number of wafers processed at one time is reduced, lowering the production yield of the wafers (hereinafter, referring to as product wafers). Such limitation is resolved by lengthening the process tube and the boat, compensating the loss of product wafers involved in providing thermal junction points. As a result, an area for providing the heater unit is extended, increasing the manufacturing expense of IC. Moreover, the thermocouples are wound around the boat so as to connect temperature measuring portions thereof to the wafers. Accordingly, when the boat is separated from a sealing cap for maintenance or repair thereof, it requires a great deal of time. Furthermore, if the thermocouples are improperly wound therearound, transmission of a process gas and a thermal energy from the heater unit to the wafers is hindered.

In order to overcome a cumbersome task of winding the thermocouples, it may be considered to leave the thermocouple-connected wafers on the boat, but since the residues of reaction products or partially reacted products of the process gas are accumulated on the wafers whenever a batch process is performed, differences in the temperatures between the thermocouple-connected wafers and the product wafers are gradually increased.

### SUMMARY OF THE INVENTION

It is, therefore, an object of the present invention to provide a semiconductor fabricating technique providing an improved heat treatment by accurately measuring and detecting any changes in the actual temperatures of target substrates to be processed.

In accordance with a preferred embodiment of the present invention, there is provided a semiconductor device fabricating apparatus, comprising:

a reaction chamber for processing a target substrate;

a temperature measuring member having thermal characteristics identical or substantially identical to those of the target substrate, a maximum outer diameter smaller than that thereof, and a thickness identical or substantially identical to that thereof; and

a thermocouple for measuring an inner temperature of the reaction chamber, the thermocouple having a thermal junction point,

wherein the temperature measuring member is connected to the thermal junction point of the thermocouple.

In accordance with another preferred embodiment of the present invention, there is provided a semiconductor device fabricating apparatus comprising:

a reaction chamber for processing a target substrate;

a temperature measuring member having thermal characteristics identical or substantially identical to those of the target substrate and a maximum outer diameter smaller than that thereof, wherein the temperature measuring member has a first and a second surfaces being opposite to each other;

a thermocouple for measuring an inner temperature of the reaction chamber, the thermocouple having a thermal junction point to which the first surface of the temperature measuring member is connected; and

a heater unit for heating the reaction chamber,

wherein the temperature measuring member is positioned between the heater unit and the target substrate, and the second surface of the temperature measuring member faces the heater unit.

In accordance with still another preferred embodiment of the present invention, there is provided a method for fabricating a semiconductor device comprising the steps of:

loading a target substrate into a reaction chamber;

heating the reaction chamber;

measuring an inner temperature of the reaction chamber by using a thermocouple and a temperature measuring member, the temperature measuring member having thermal characteristics identical or substantially identical to those of the target substrate, a maximum outer diameter smaller than that thereof, and a thickness identical or substantially identical to that thereof and the thermocouple having a thermal junction point connected thereto;

controlling the inner temperature of the reaction chamber based on the temperature measurement;

processing the target substrate by supplying process gas into the reaction chamber, to thereby obtain a product substrate;

reducing the inner temperature of the reaction chamber; and

unloading the product substrate from the reaction chamber.

With such a construction, the temperature of temperature measuring member follows that of the target substrate, since the thermal characteristics thereof is identical or substantially identical to the target substrate. The temperature of the temperature measuring members detected by using the thermocouple is a close replica of an actual temperature of the target substrate and reflects any changes in the actual temperature of the target substrate. Furthermore, a temperature controller can carry out a feedback control on a heater unit based on the temperature measured by the thermocouple (or the actual temperature of the target substrate) in an excellent response thereto. Accordingly, it allows for an optimal heat treatment.

Moreover, the thermocouple is connected with not the target substrate but the temperature measuring member, which has a smaller outer diameter than that of the target substrate, thus the temperature measuring member and the thermocouple connected therewith is arranged independent of the placement of the target substrate.

### BRIEF DESCRIPTION OF THE DRAWINGS

The above and other objects and features of the present invention will become apparent from the following description of preferred embodiments given in conjunction with the accompanying drawings, in which:

FIG. 1 shows a front cross sectional view of a vertical hot-wall type batch heat treatment apparatus in accordance with a first preferred embodiment of the present invention;

FIG. 2A describes an expanded view of part “A” in FIG. 1, and FIG. 2B to 2D present a partial cross sectional side view, a partial cross sectional rear view and a partial cross sectional top plan view setting forth a connection of a thermocouple and a temperature measuring member included in the vertical hot-wall type batch heat treatment apparatus of FIG. 1, respectively;

FIGS. 3A and 3B depict graphs illustrating rising characteristics in temperature of prior art and preferred embodiment of the present invention, respectively;

FIG. 4 represents a partial perspective view setting forth an installation of a temperature measuring member in accordance with a second preferred embodiment of the present invention;

FIG. 5 offers a cross sectional front view of a hot-wall type single substrate heat treatment apparatus in accordance with a third preferred embodiment of the present invention;

FIG. 6 provides a cross sectional top plan view of the hot-wall type single substrate heat treatment apparatus of FIG. 5;

FIG. 7A describes an expanded view of a modification of part “A” in FIG. 1; and FIG. 7B to 7D present a partial cross sectional side view setting forth an arrangement of temperature measuring members and a thermocouple in FIG. 7A, a cross sectional view taken along the line A-A of FIG. 7B and a partial cross sectional plan view of the arrangement shown in FIG. 7A, respectively;

FIGS. 8A and 8B illustrate a partial cross sectional side view setting forth a detailed arrangement of the temperature measuring members and the thermal junction points shown in FIG. 7B and a modification of FIG. 8A, respectively;

FIG. 9 discloses a partial perspective view setting forth a modified installation of the temperature measuring member in accordance with the second preferred embodiment of the present invention;

FIG. 10 is a cross sectional front view of a modification of the hot-wall type single substrate heat treatment apparatus in accordance with the third preferred embodiment of the present invention; and

FIG. 11 sets forth a cross sectional plan view of the hot-wall type single substrate heat treatment apparatus of FIG. 10.

### DETAILED DESCRIPTION OF THE PREFERRED EMBODIMENTS

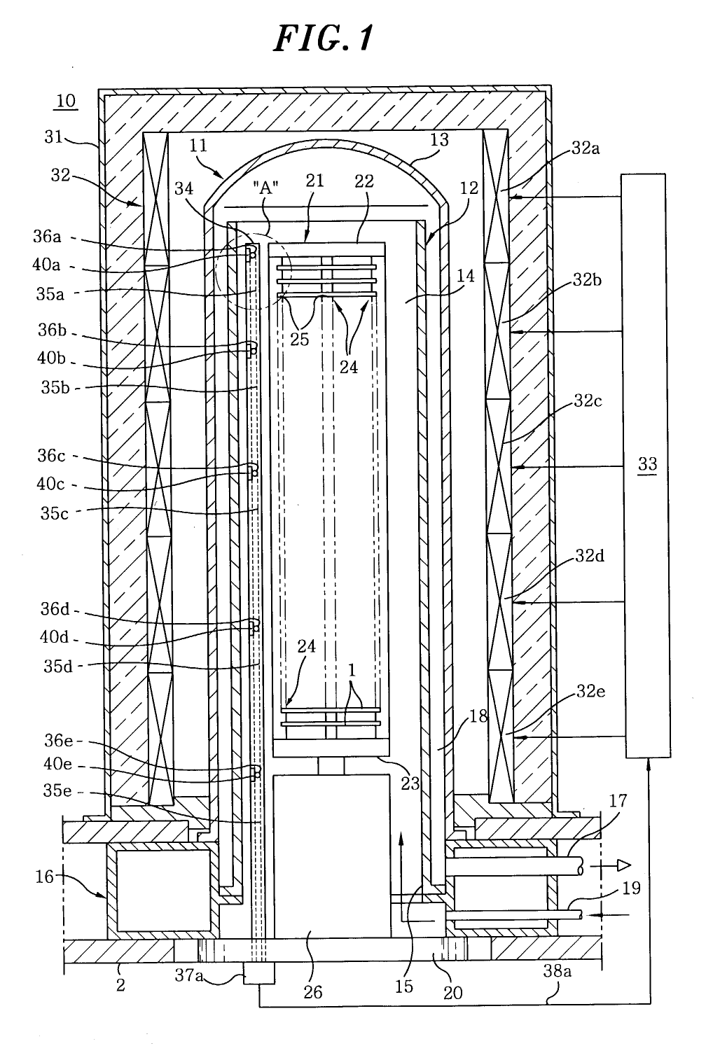

Referring to FIG. 1, there is shown a front cross sectional view of a hot-wall type heat treatment apparatus 10 (a vertical hot-wall type batch heat treatment apparatus) in accordance with a first preferred embodiment of the present invention, wherein the hot-wall type heat treatment apparatus 10 carries out the heat treatment on target substrates, e.g., wafers 1 for use in fabricating IC.

As shown, the hot-wall type heat treatment 10 includes a process tube 11 fixedly disposed in such a manner that its longitudinal centerline is vertical as viewed from FIG. 1. The process tube 11 formed in a cylindrical shape, contains an inner tube 12 made of quartz glass or SiC and an outer tube 13 also formed in a cylindrical shape, made of quartz glass. The cylindrical inner tube 12 has an open top and bottom, and a hollow portion therebetween. The hollow portion constitutes a reaction chamber 14 into which a plurality of vertically stacked wafers 1 in a boat 21 are loaded. In order to utilize the open bottom of the inner tube 12 as a furnace mouth 15 for loading/unloading the wafers 1 therethrough, the inner tube 12 is set to have an inner diameter larger than a maximum outer diameter(e.g., 300 mm) of the wafers 1.

The cylindrical outer tube 13 having a closed top and an open bottom as viewed in FIG. 1 concentrically compasses the inner tube 12 with a space provided therebetween. A lower portion of the space is tightly sealed with a stepped cylindrical manifold 16. The manifold 16 is detachably installed at the inner tube 12 and the outer tube 13 to facilitate replacing of both tubes 12 and 13 with new inner and outer tube. Since the manifold 16 is supported by a housing 2 of the hot-wall type heat treatment apparatus 10, the process tube 11 can be vertically placed.

The manifold 16 is provided with a sidewall having an upper part to which an exhaust pipe 17 communicating with an exhaust apparatus (not shown) is connected, so that gases inside of the process tube 11 are discharged therethrough. Specifically, the exhaust pipe 17 communicates with the space acting as an exhaust passage 18 between the inner tube 12 and the outer tube 13, the exhaust passage 18 having a ring shape with a predetermined dimensions. Since the exhaust pipe 17 is installed at the manifold 16, the exhaust tube 17 is provided to a lowest part of the exhaust passage 18 forming a cylindrical hollow body.

The sidewall of the manifold 16 further has a lower part to which a gas inlet pipe 19 is connected. One end of the gas inlet pipe 19 communicates with the furnace mouth 15 of the inner tube 12, and the other end thereof is connected to devices (not shown) for respectively supplying raw gas, carrier gas and purge gas. Gases introduced into the reaction chamber 14 through the gas inlet pipe 19 and the furnace mouth 15 circulate inside thereof, and are discharged to the outside via the exhaust passage 18 and the exhaust pipe 17 communicating therewith.

Further, the manifold 16 has a lower portion on which a seal cap 20 is vertically abutted from below. The seal cap 20 for closing an opening formed at the bottom of the apparatus 10 is of a circular shape having a substantially identical outer diameter to that of the manifold 16. The seal cap 20 is constructed such that it is vertically moved by a boat elevator (not shown) provided outside of the process tube 11. The boat 21 concentrically installed with a central portion of the seal cap 20 is thereby vertically supported.

The boat 21 has a top plate 22, a bottom plate 23, and three supports 24 vertically installed therebetween. The supports 24 are provided with a plurality of slit sets equally spaced apart from each other, each of the slit sets having three slits 25 which are respectively formed at the supports 24 having the same vertical heights. The boat 21 is provided with a plurality of horizontally disposed wafers 1 with their centers vertically aligned by inserting the peripheries thereof into their corresponding three slits 25. Between the boat 21 and the seal cap 20 is disposed a heat insulating cap 26 incorporating a heat insulating material inserted thereinto. The heat insulating cap 26 supports the boat 21 in such a manner that the boat 21 is maintained above the seal cap 20. Therefore, the boat 21 is allowed to be spaced apart from the furnace mouth 15 by a predetermined distance.

Referring to FIG. 1, the exterior of the process tube 11 is housed by a heat insulating vessel 31 and an inner periphery of the heat insulating vessel 31 is provided with a heater unit 32 concentrically surrounding the outer tube 13 so as to heat the inside of the process tube 11. The heat insulating vessel 31 is made of, e.g., a stainless steel, by making a cylindrical cover from a thin plate made of the stainless steel and inserting thereinto a heat insulating material such as glass wool. The heat insulating vessel 31 is of a cylindrical shape having an inner diameter larger than that of the process tube 11 and a vertical height slightly higher than that of the process tube 11. The heat insulating vessel 31 having such construction is supported by the housing 2 to be vertically installed thereat. The inner periphery of the heat insulating vessel 31 is wound with a linear electric resistor, e.g., a nichrome wire, forming the heater unit 32. The heater unit 32 is divided into five portions, i.e., a first heater portion to a fifth heater portion 32a to 32e. These heater portions 32a to 32e are controlled by a temperature controller 33. Specifically, the temperature controller 33 performs a sequential control on the heater unit 32 so that the heater portions 32a to 32e are independently or consecutively controlled.

As shown in FIG. 1, a protective sheath 34 is vertically and fixedly installed 34 at an edge of the seal cap 20 without being in contact with the boat 21. Specifically, when the boat 21 is loaded into the reaction chamber 14, the protective sheath 34 is set to be disposed between the boat 21 and the inner tube 12. The protective sheath 34 is provided with a set of thermocouple having a plurality of, e.g., five thermocouples 35a to 35e. The thermocouples 35a to 35e sealed with the protective sheath 34 are electrically connected to the temperature controller 33, to output temperatures measured thereby, respectively. The temperature measurements taken by the respective thermocouples 35a to 35e are used by the temperature controller 33 in providing feedback control to the respective heater portions 32a to 32e. More specifically, the temperature controller 33 compares reference temperatures of the respective heater portion 32a to 32e with the temperature measured by the thermocouples 35a to 35e and computes any error therebetween. Such error that may exist is negated by the feedback control of the temperature controller 33.

The respective thermocouples 35a to 35e have their corresponding thermal junction points 36a to 36e, where the temperature measurements are taken. The thermal junction points 36a to 36e are disposed in such a manner that their vertical positions correspond to those of the heater portions 32a to 32e, respectively. At the thermal junction points 36a to 36e are attached temperature measuring members 40a to 40e, respectively. The thermal junction points 36a to 36e are made of a semi-conductive or nonconductive material, e.g., a silicon having thermal characteristics identical or similar to that of the wafers 1, which are attached to the temperature measuring members 40a to 40e, respectively having dimensions of 3 mm×6 mm×1 mm.

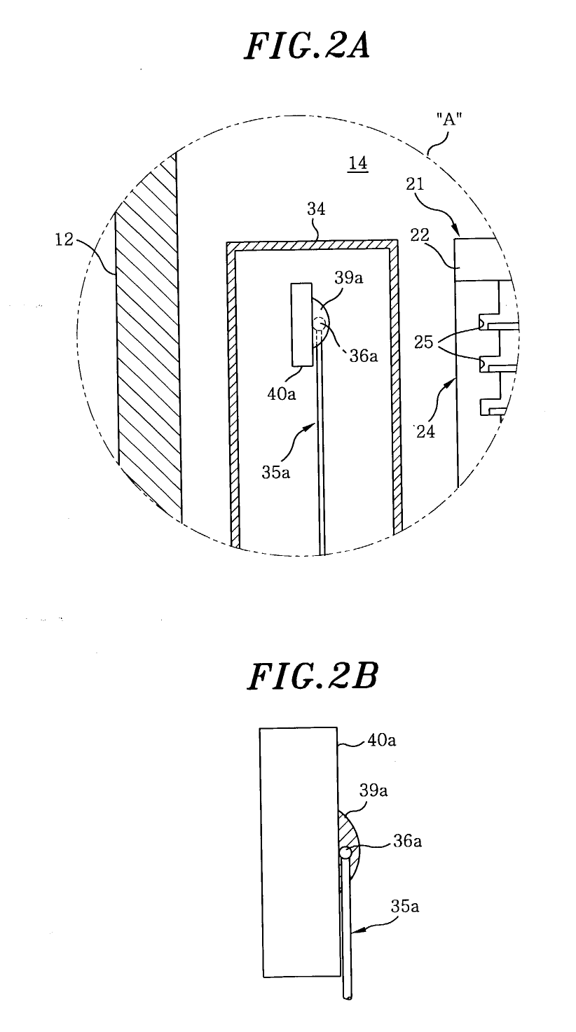

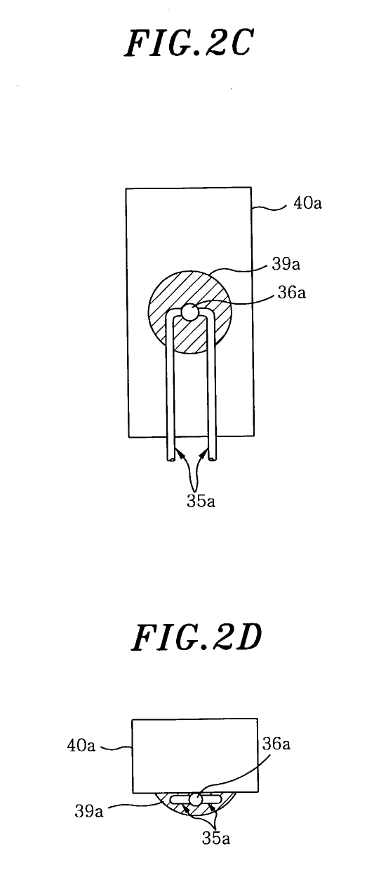

A construction of the thermocouples 35a to 35e and the temperature measuring members 40a to 40e and a connection therebetween will now be described with reference to FIGS. 1 and 2A to 2D. For the sake of simplicity, only the heater portion 32a and the thermocouple 35a corresponding thereto will be described.

The thermocouple 35a has thermocouple wires made of, e.g., Pt wire or Pt-Rh wire. As shown in FIG. 1, the thermocouple 35a has a receiver 37a disposed at the bottom of the protective sheath 34. Between the receiver 37a and the temperature controller 33, an electric wire 38a is provided for electrically connecting therebetween to output the temperature measured by the thermocouple 35a to the temperature controller 33. Referring to FIGS. 2A to 2D, the temperature measuring member 40a has a front and a rear sides and is connected with the thermocouple 35a at a vertical location corresponding to the heater portion 32a in the protective sheath 34. Disposed in the center of the rear side of the temperature measuring member 40a facing the boat 21 is the thermal junction point 36a, bonded by a heat resistant adhesive 39a made of, e.g., alumina (ceramic). On the other hand, the front side of the temperature measuring member 40a faces the heater portion 32a.

It is preferable that the temperature measuring member 40a has thermal characteristics identical or substantially identical to those of the wafer 1 to be processed, so that any changes in temperature in the wafer 1 can be reflected in the temperature measuring member 40a. More specifically, the thermal characteristics of the temperature measuring member 40a should meet the following three conditions.

(1) Product of specific heat and density of the temperature measuring member 40a.

First, heat transfer needed to raise the temperature of the temperature measuring member to the reference temperature of the heater unit can be obtained by equation \mathring{1} and similarly for wafers, same can be obtained for wafers by equation \mathring{2} below.

Qc=Mc×Cc×(Th−Tc)=Vc×ρc×Cc×(Th−Tc) Eq. 1

Qw=Mw×Cw×(Th−Tw)=Vw×ρw×Cw×(Th−Tw) Eq. 2

wherein the subscript c represents temperature measuring member; the subscript w, wafers; the subscript h, temperature of the heater unit; Q, heat transfer; M, mass; C, specific heat; T, temperature; V, volume; and p, density.

In Eqs. 1 and 2, if the heat transfer per unit volume of the temperature measuring member 40a and the wafers 1, i.e., Qc/Vc and Qw/Vw, are the same under the same temperature condition, it follows that

ρ c×Cc=ρ w×Cw Eq. 3

Since radiation from the heater unit is equally transmitted to the temperature measuring member and the wafers 1, heat transfer per unit of area are the same. Thus, if the temperature measuring member has an identical thickness to that of the wafers, the heat transfer per unit of volume becomes the same, and accordingly yields Qc/Vc and Qw/Vw that are identical.

In view of Eq. 3, it is found that it is unnecessary to set the volume of the temperature measuring member 40a and that of the wafer 1 to be identical, as long as the product of specific heat and density, and the thickness of the temperature measuring member 40a are identical to those of the wafers 1.

(2) It is required that the emissivity(an absorptivity) of the temperature measuring member 40a be identical or substantially identical to the wafer, per unit area. The equation relating to the radiation exchange between two bodies is generally known as follows:

Q=A₁×X₁₂×σ×(T₁⁴−T₂⁴) Eq. 4

wherein X₁₂=1/{1/ε₁+(1/ε₂−1)×A₁/A₂}; Q is heat transfer; σ, Stefan-Boltzmann's constant, T₁ and T₂, temperatures of two bodies; A₁ and A₂, areas of two bodies; and ε₁ and ε₂, emissivities of two bodies.

Eq. 4 is applied to the temperature measuring member and the wafers, per unit area. If the temperature of the heater unit(Th) reaches a certain temperature, Q of the temperature measuring member and the wafers become the same, and finally it follows that

εc=εw Eq. 5

That is, the emissivity of the temperature measuring member 40a should be identical or substantially identical to the wafers, per unit area.

Further, it is known that the absorptivity is identical to the emissivity by Kirchhoff's law (i.e., the emissivity (ε) and the absorptivity (α) of radioactive rays in a heat radiator having an identical wavelength are the same). Accordingly, only one of the two needs to be defined.

(3) it is required that the thermal conductivity of the temperature measuring member 40a be identical or substantially identical to the wafers. The thermal conductivity is generally calculated by a following equation;

Q=−λ×(ΔT/Δ×)×A Eq. 6

wherein, Q is heat transfer; λ, thermal conductivity; ΔT, change in temperature; Δx, an inner spacing of a body; and A, an area to which the heat is transmitted.

For instance, when λ of the temperature measuring member is extremely small (i.e., the thermal conductivity is poor), it yields low heat transfer to the thermal junction point of the thermocouple, deteriorating the response of the control process. On the other hand, if λ of the temperature measuring member is extremely large, the temperature of the temperature measuring member exceeds the actual temperatures of the wafers and thus errors are generated therebetween (when stabilized the temperature of the temperature measuring member becomes identical to that of the wafers). Therefore, it is preferable that their thermal conductivities are identical or substantially identical.

In this embodiment, since the temperature measuring member 40a is made of a material similar to that of the wafer 1, i.e., silicon, the product of specific heat and density, the thermal conductivity, and the emissivity (the absorptivity) thereof are identical to those of the wafers 1. Accordingly, the temperature measuring member 40a can have small dimensions and can still efficiently reflect temperature changes in the wafers 1.

A heat treatment process for fabricating IC in accordance with the first embodiment of the present invention will now be described.

Returning to FIG. 1, the boat 21 placed on top of the seal cap 20 in which the wafers 1 are vertically aligned, is lifted by the boat elevator and loaded into the reaction chamber 14 through the furnace mouth 15 formed at the inner tube 12. Thereafter, the boat 21 is disposed in the reaction chamber 14, supported by the seal cap 20.

Sequentially, the interior atmosphere of the process tube 11 is evacuated via the exhaust pipe 17 and at the same time, is heated by the respective heater portions 32a to 32e till the reference temperature of the sequential control of the temperature controller 33 (e.g., ranges from about 600 to about 1200° C.) is reached, at which time, discrepancy in temperature between an inner temperature of the process tube 11 raised by the heater portions 32a to 32e and the reference temperature of the sequential control is corrected by the feedback control of the temperature controller 33.

In this embodiment, the respective temperature measuring members 40a to 40e have the thermal characteristics identical or substantially identical to those of the wafers 1. Consequently, the temperatures of the temperature measuring members 40a to 40e accurately reflect the temperature changes in the wafers 1. Further, since the thermal junction points 36a to 36e of the thermocouples 35a to 35e are connected to the temperature measuring members 40a to 40e, the thermocouples 35a to 35e accurately measure the temperature changes in the respective temperature measuring members 40a to 40e. In other words by using the independent thermocouples 35a to 35e, the temperature changes in the wafers 1 can accurately be measured.

Finally, depending on the temperatures measured by the respective thermocouples 35a to 35e, i.e., the actual temperatures of the wafers 1, the temperature controller 33 can perform the feedback control on the respective heater portions 32a to 32e immediately.

Moreover, since the front sides of the temperature measuring members 40a to 40e face the heater portions 32a to 32e in a single protective sheath 34, the radiation heat from the heater portions 32a to 32e is vertically transmitted to the temperature measuring members 40a to 40e. As a result, the inventive heat treatment apparatus 10 can detect the temperature changes of the wafers 1 having an improved response thereto.

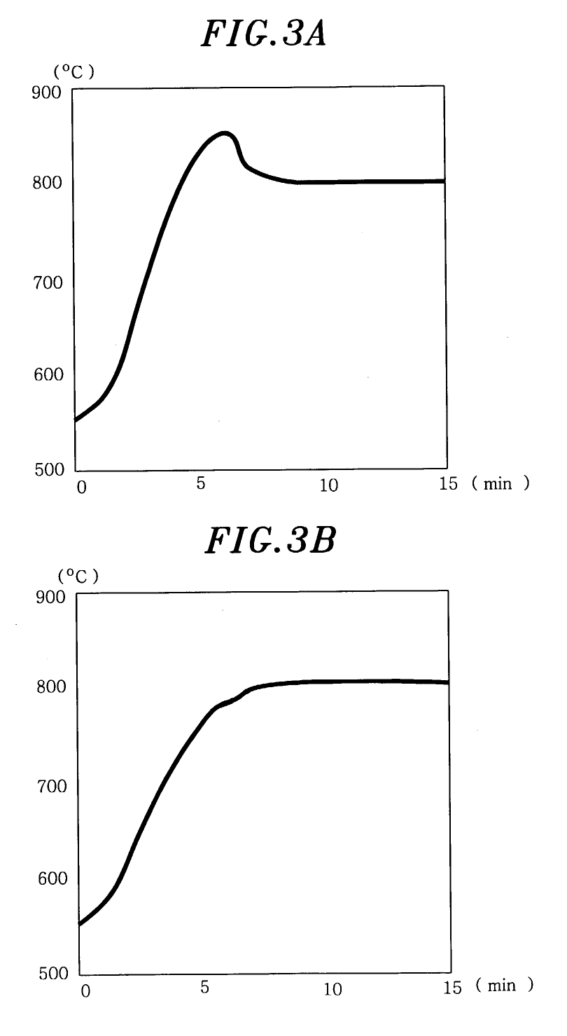

It is experimentally found that, when temperature measuring members are parallel to wafer surfaces (i.e., to be perpendicular to the heater unit), the temperature measuring members less accurately reflect the actual temperature of the wafers than the arrangement of the temperature measuring members in accordance with the present invention. This may be because the wafers in the boat receives radiation heat from the heater unit vertically, directly on its upper and lower surface, while the temperature measuring members indirectly receive radiation heat therefrom via the adhesive layer of a low thermal conductivity, which is used for fixing the thermal junction points of the thermocouples on the rear side of the temperature measuring member. Accordingly, the temperatures of the temperature measuring members are lower than those of the wafers. Referring to FIGS. 3A and 3B, there are shown graphs illustrating rising characteristics of the temperature of the prior art and the present invention, respectively. In the graphs, the x-axis and the y-axis represent time (in min) and the average ambient temperature of the wafers disposed in the reaction chamber, when the standby temperature of about 550° C. is raised to the process temperature of about 800° C. at an increasing temperature rate of about 50° C./min. In FIGS. 3A and 3B, the experimental conditions are identical except for the thermocouples. In addition, the standby temperature is generally a predetermined temperature lower than the process temperature by, e.g., from about 150° C. to about 300° C., but recently it has been proposed that, after the standby temperature is set to be higher than the process temperature, the boat is loaded into the reaction chamber and then the temperature of the reaction chamber is reduced from the standby temperature to the process temperature.

As shown in FIG. 3A representing the rising characteristics of the temperature of prior art, when the temperature of the reaction chamber is rapidly increased at the rate of about 50° C./min, the temperature of the thermocouple is lower than the actual temperature of the wafer, inducing an overshoot phenomenon of the temperature, in which the temperature of the wafer exceeds the reference temperature of the heater unit. Further, it takes time for the overshot temperature to reach the reference temperature. Thus, a start of the heat treatment process is delayed in the prior art, extending a total heat treatment time period.

In comparison, since the temperature of the thermocouple is substantially identical to that of the wafer in this embodiment, the overshoot phenomenon is minimized as shown in FIG. 3B. Accordingly, since it is possible to reduce the time taken to reach the reference temperature, the start of the heat treatment process is expedited, reducing the total heat treatment time.

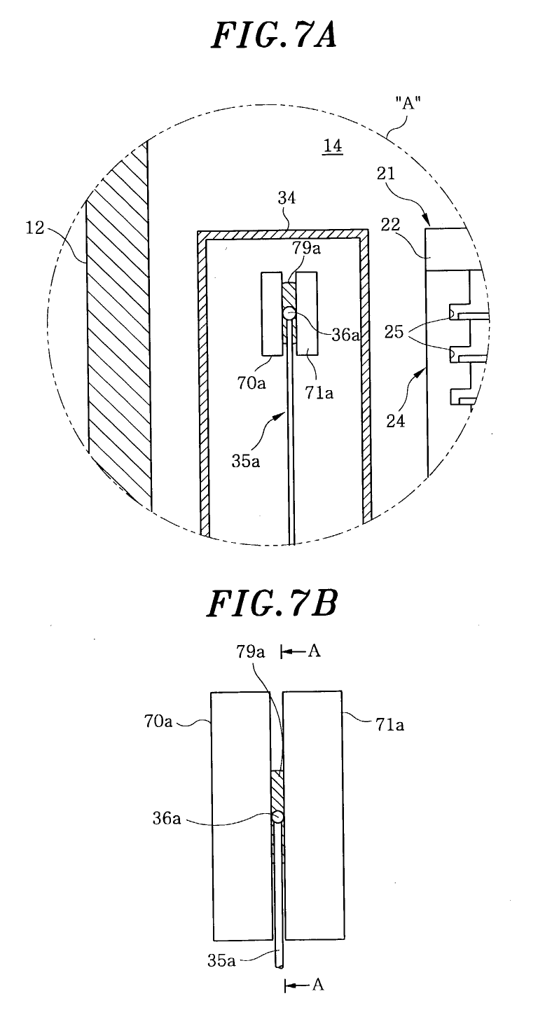

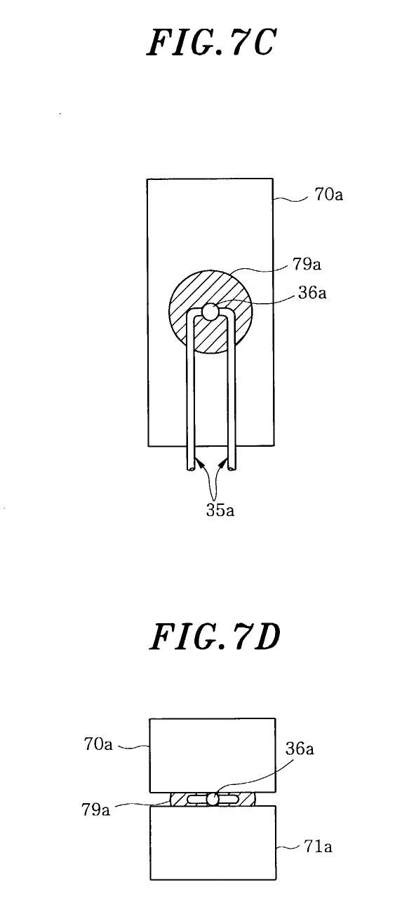

The number of temperature measuring members to be attached to a thermal junction point of a single thermocouple may be two, such that the thermal junction point is interposed between the two temperature measuring members. FIG. 7A discloses an alternative of the arrangement of the temperature measuring member and the thermal junction points 36a to 36e of the thermocouples 35a to 35e in protective sheath 34 shown in FIG. 1; and FIGS. 7B to 7D present a partial cross sectional side view setting forth an arrangement of the temperature measuring members and the thermocouple shown in FIG. 7A, a cross sectional view taken along the line A-A of FIG. 7B and a partial cross sectional plan view of the arrangement shown in FIG. 7A, respectively.

As shown in FIGS. 7A to 7D, a temperature measuring member 70a connected with the thermal junction points 36a of the thermocouple 35a is disposed in the protective sheath 34 at a position facing the heater portion 32a. Similarly in the protection sheath 34, another temperature measuring member 71a facing the boat 21 is also connected with the thermal junction point 36a of the thermocouple 35a, so that the thermal junction point 36a of the thermocouple 35a is interposed between the temperature measuring members 70a and 71a at the central portions thereof. Such interposed thermal junction point 36a of the thermocouple 35a is bonded to the temperature measuring members 70a and 71a with a heat resistant adhesive 79a, e.g., alumina (ceramic) adhesive.

Above described arrangement enables the radiation heat from the heater portion 32a to be vertically transferred to the temperature measuring member 70a facing the heater portion 32a and that from the boat 21 to be transferred to the temperature measuring member 71a locating opposite to the heater portion 32a. As a result, the inventive heat treatment apparatus 10 can detect the temperature changes of the wafers 1 with improved accuracy. The thermal junction points 36b to 36e are also connected to temperature measuring members in an identical manner described above with respect to the thermal junction point 36a.

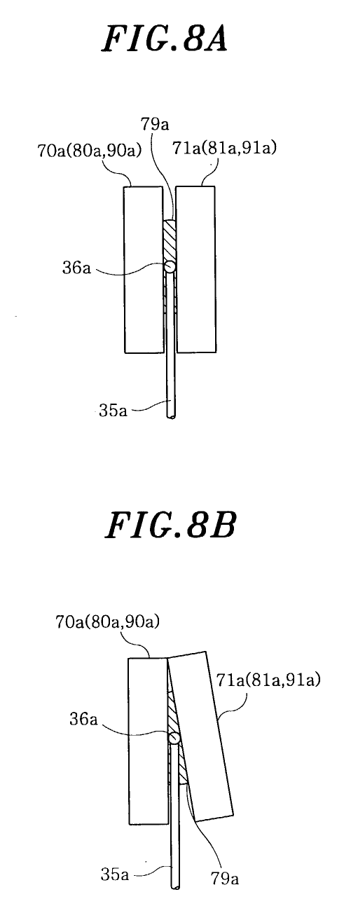

While the temperature measuring members 70a and 71a connected to the thermal junction point 36a interposed therebetween may be arranged substantially paralleled to each other as shown in FIG. 8A, the temperature measuring members 70a and 71a may also be bonded to the thermal junction point 36a in a fashion of being partially in contact with each other as shown in FIG. 8B.

When the inner temperature of the reaction chamber 14 is stabilized to a predetermined process temperature by the above-mentioned temperature control, the process gas is introduced thereinto via the gas inlet pipe 19. The process gas introduced into the reaction chamber 14 propagates and rises therein and then flows from the open top of the inner tube 12 into the exhaust passage 18 to be discharged via the exhaust pipe 17. While the process gas flows in the reaction chamber 14, it comes in contact with the wafers 1 to carry out the heat treatment on the surfaces thereof.

After the predetermined time period for performing such a heat treatment has elapsed, a heating operation of the heater portions 32a to 32e is stopped by the sequential control of the temperature controller 33 which in turn reduces the inner temperature of the process tube 11 to the preset standby temperature (e.g., the temperature lower than the process temperature by, e.g., from about 150° C. to about 300° C.). At this time, discrepancies between the actual temperature of which the inner temperature of the process tube 11 is reduced by the respective heater portions 32a to 32e of the heater unit 32 and the reference temperature of the sequential control thereof are respectively corrected by the feedback control based on the temperatures measured by the thermocouples 35a to 35e. In this case, since the respective thermocouples 35a to 35e immediately measures the temperatures changed in the wafers 1, the temperature controller can carry out the feedback control on the respective heater portion 32a to 32e with enhanced response to the actual temperature changes in the wafers 1.

When the preset standby temperature is reached or the preset temperature reduction time period has elapsed, the seal cap 20 moves down to open the furnace mouth 15 and simultaneously, the boat 21 holding the wafers 1 mounted therein are unloaded from the process tube 11 via the furnace mouth 15.

The above-explained operations are repeated to apply the batch process for the wafers 1 by means of the batch type heat treatment apparatus, to thereby obtain the following effects.

That is, (1) the temperature measuring members having the thermal characteristics identical or similar to those of the wafers are coupled to the thermal junction points of the thermocouples, which in turn, allows the thermocouples to measure the actual temperatures and precisely detect changes in temperatures in the wafers. Therefore, the temperature controller connected to the thermocouples can perform the feedback control on the heater unit with excellent response based on the temperatures of the wafers measured by the thermocouple, providing an appropriate heat treatment in the hot-wall type heat treatment apparatus.

(2) The front side opposite to the rear side connected to the thermal junction points is provided to face the heater unit, which in turn, enables the temperature measuring members to vertically receive the radiation heat therefrom, permitting the thermocouples to measure the actual temperatures of the wafers, further enhancing the accuracy of the temperature measurement of the wafers.

(3) By connecting the thermocouples to the wafers through the temperature measuring members, a loss of efficiency for the heat treatment in fabricating IC can be prevented without reducing the number of product wafers processed at one time.

(4) By connecting the thermocouples to the wafers through the temperature measuring member, the thermocouples can be installed independent of the placement of the boat, and the wire layout for the thermocouples can be freely designed, which facilitates maintenance and repair of the thermocouples.

(5) The installation layout for the temperature measuring members and the thermocouples can manage to be inside of the process tube in such a manner that the process gas and the radiation heat from the heater unit are transmitted to the wafers, enhancing precision and reliability of the heat treatment process of the hot-wall type heat treatment apparatus.

(6) The dimensions, i.e., the length and the width, of the temperature measuring members are set to be smaller than the diameter of the wafers, which in turn, increase degree of freedom for installation thereof, thereby enabling placement of the protective sheath at the seal cap.

(7) By installing small temperature measuring members in the protective sheath fastened to the seal cap, the temperature measuring members can be loaded/unloaded into/from the reaction chamber, which facilitates maintenance and repair of the temperature measuring members, e.g., eliminating the reaction products or the partially reacted products of the process gas deposited thereon, thereby further reducing difference in the temperature between the temperature measuring members and the wafers.

(8) By disposing, preferably parallel to the heater unit 32, the pair of temperature measuring members facing each other and having one thermal junction point interposed therebetween, the temperature measuring members can receive the radiation heat vertically transmitted from the heater unit 32 and that from the boat 21 disposed opposite to the heater portion 32a. As a result, the thermocouples can further accurately reflect the temperature in the wafers 1.

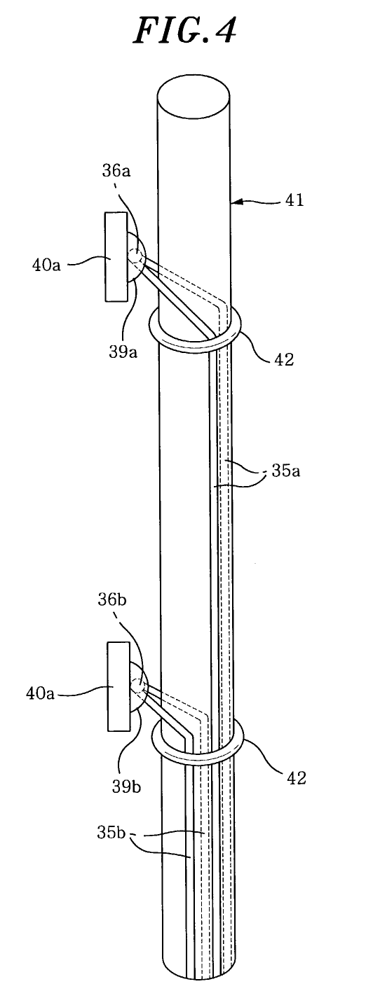

Referring to FIG. 4, there is shown an installation of a temperature measuring member in accordance with a second preferred embodiment of the present invention. Like parts appearing FIGS. 1 to 4 are represented by like reference numerals.

This embodiment is similar to the first one except for a multiplicity of thermocouples 35a and 35b . . . (only two shown) fixedly installed on a periphery of a support rod 41 by using a number of rings 42 (only two shown).

In order for a plurality of temperature measuring members 40a and 40b . . . (only two shown) to vertically receive radiation heat from the heater portions 32a, 32b . . . to improve response to the temperature changes in the wafers 1, it is preferable that the front sides of the temperature measuring members 40a and 40b . . . face the respective heater portions 32a, 32b . . . , the front sides being opposite to the rear sides to which the respective thermal junction points 36a, 36b . . . of the temperature measuring members 40a and 40b . . . are fixed.

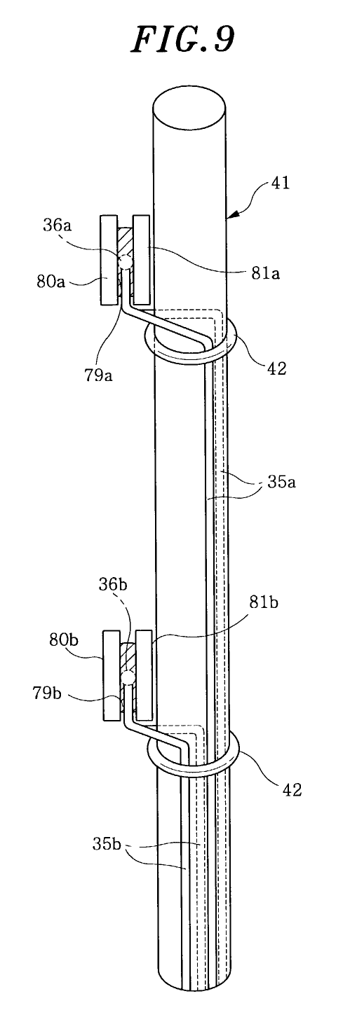

Referring to FIG. 9, there is illustrated a modification of the second preferred embodiment in accordance with the present invention set forth with reference to FIG. 4. Also in FIG. 9, the temperature measuring members 80a, 80b . . . (only two shown) are configured to vertically receive the radiation heat from the heater portions 32a, 32b . . . and the temperature measuring members 81a, 81b . . . (only two shown) are arranged to receive the radiation heat from the boat 21 disposed opposite to the heater portions 32a, as well. This allows the temperature measuring members to detect the temperature changes of the wafers 1 with further enhanced accuracy. As such, it is preferable that the respective pair of the temperature measuring members 80a, 81a and 80b, 81b are connected to the thermal junction points 36a, 36b in such a manner that the temperature measuring members 80a, 80b face corresponding heater portions and the temperature measuring members 81a, 81b face the boat 21.

While the temperature measuring members 80a and 81a coupled to the thermal junction point 36a interposed therebetween can be arranged substantially paralleled to each other as shown in FIG. 8A, they may also be bonded to the thermal junction point 36a in a manner of being in partial contact with each other as shown in FIG. 8B.

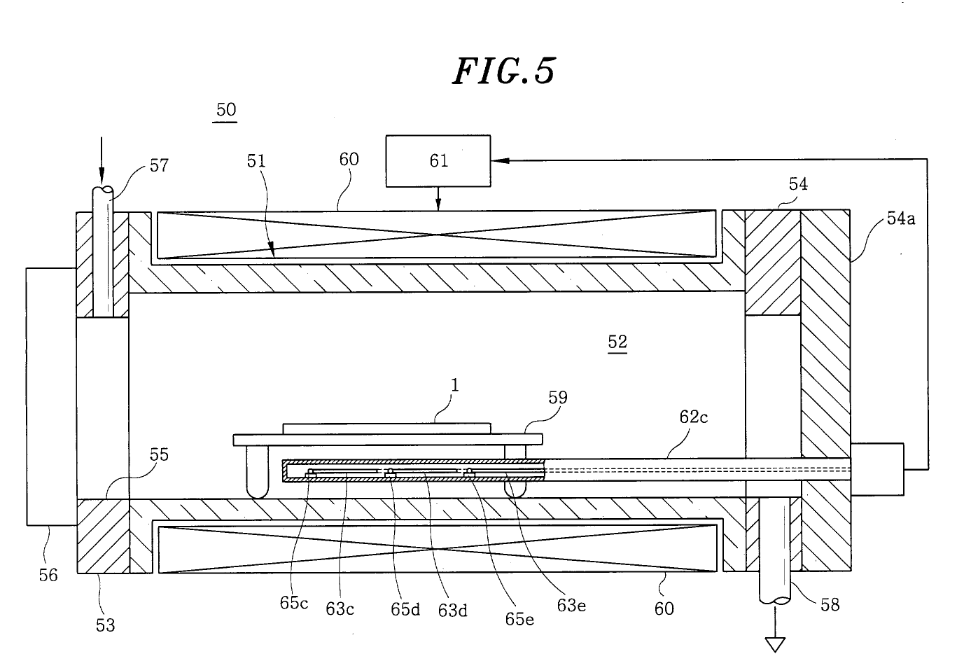

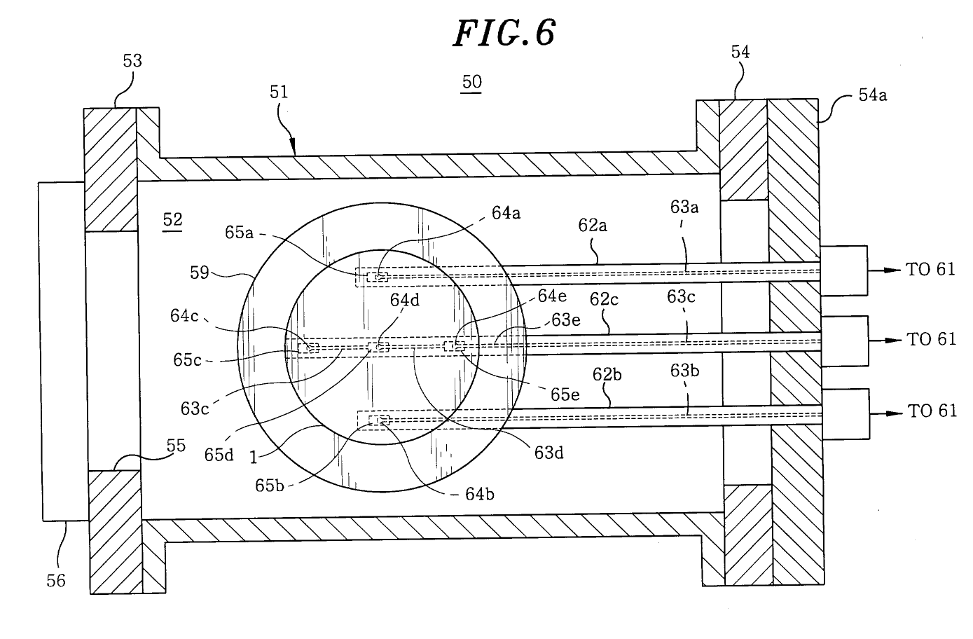

Referring to FIGS. 5 and 6, there are respectively shown a front cross sectional view and a top plan view of a hot-wall type single substrate heat treatment apparatus 50 for fabricating IC in accordance with a third preferred embodiment of the present invention. Similar to the above-mentioned embodiments, a reference numeral 1 represents the wafer.

As shown, the hot-wall type single substrate heat treatment apparatus 50 includes a process tube 51 defining a reaction room 52. The reaction room 52 has a rectangular shape as viewed from a plane thereof for accommodating the wafers 1. The process tube 51 made of quartz glass or SiC is formed in a rectangular parallelepiped shape having a vertical distance smaller than a horizontal distance and is horizontally or flatly supported by a housing (not shown).

Furthermore, the process tube 51 has a pair of open ends facing each other at which a furnace inlet flange 53 having a furnace inlet opening 55 and a furnace outlet flange 54 are respectively provided. The furnace inlet opening 55 for loading/unloading the wafers 1 into/from the reaction room 52 therethrough is selectively closed by a gate valve 56.

The furnace inlet flange 53 and the furnace outlet flange 54 are respectively provided with a gas inlet passage 57 communicating with the furnace inlet opening 55 and a gas outlet passage 58 communicating with the reaction room 52. Further, the furnace outlet flange 54 is closed by a cap 54a. This allows a process gas introduced from the gas inlet passage 57 to flow inside of the reaction room 52 and finally discharged through the gas exhaust passage 58.

At the bottom of the reaction room 52 is installed a placement table 59 for horizontally or flatly mounting thereon one wafer 1. In order to maintain the reaction room 52 having a uniform or a predetermined temperature distribution, an outside of the process tube 51 is provided with a heater unit 60 for heating the reaction room 52. The heater unit 60 is controlled by a temperature controller 61, performing a sequential control and a feedback control.

As shown in FIG. 6, two side protection sheaths 62a and 62b and one central protection sheath 62c located therebetween are fixedly and longitudinally inserted into the cap 54a in such a manner that they are disposed in the reaction room 52 to have an identical vertical distance. Each of the protection sheaths 62a to 62c has a distal end portion right below the edge of the wafer 1 placed on the placement table 59.

Two thermocouples 63a and 63b having their corresponding thermal junction points 64a and 64b are respectively inserted into the side protection sheaths 62a and 62b and three thermocouples 63c, 63d and 63e having their corresponding thermal junction points 64c, 64d and 64e are inserted into the central protection sheath 62c.

As clearly shown in FIG. 6, the thermal junction points 64a and 64b are disposed in the distal end portion of the side protection sheaths 62a and 62b, opposite to each other, and the thermal junction points 64d is located in the distal end portion of the central protection sheath 62c, positioned between the thermal junction points 64a and 64b. Further, the thermal junction points 64c and 64e are also displaced in the distal end portion of the central protection sheath 62c to be circumferentially and equally spaced apart from the thermal junction points 64a and 64b. The thermal junction points 64a to 64e are electrically connected with temperature measuring member 65a to 65e, respectively.

A construction of the thermocouples 63a to 63e and the temperature measuring members 65a to 65e and a connection therebetween are similar to the first embodiment, and therefore omitted herein.

The thermocouples 63a to 63e are independently and electrically connected to the temperature controller 61 to measure inner temperatures of the reaction room 52 and then to output the measured temperatures to the temperature controller 61. Based on the results of the temperature outputted from the thermocouples 63a to 63e, the temperature controller 61 carries out the feedback control on the heater unit 60. Specifically, the temperature controller 61 computes discrepancies between the reference temperature of the heater unit 60 and the temperatures measured by the thermocouples 63a to 63e, and performs the feedback control to minimize such discrepancies.

A heat treatment process of the hot-wall type single substrate heat treatment apparatus 50 will now be described.

First, the wafer 1 to be processed is handled by a wafer transfer system (not shown) to be loaded into the reaction room 52 through the furnace inlet opening 55, and then mounted on the displacement table 59 as shown in FIGS. 5 and 6.

After the furnace inlet opening 55 is closed by the gate valve 56, inner gases of the reaction room 52 are exhausted via the gas outlet passage 58 and simultaneously, the inside thereof is heated till the reference temperature of the sequential control of the temperature controller 61 (e.g., ranges from about 600 to about 1200° C.) is reached. At this time, the discrepancy between the actual rising temperature of the reaction room 52 attributed to the heater unit 60 and the reference temperature of the sequential control are respectively corrected by the sequential control of the temperature controller 61, the sequential control of the temperature controller 61 being carried out based on the temperatures detected by the respective thermocouples 63a to 63e.

In this embodiment as well, the independent temperature measuring members 65a to 65e have the thermal characteristics identical or substantially identical to those of the wafer 1. Consequently, the temperatures of the temperature measuring members 65a to 65e accurately incorporate the temperature changes in the wafer 1. Further, since the thermal junction points 64a to 64e of the thermocouples 63a to 63e are connected to the temperature measuring members 65a to 65e, respectively, the independent thermocouples 63a to 63e precisely detect the temperature changes in the respective temperature measuring members 65a to 65e. In other words, the independent thermocouples 63a to 63e can accurately measure and detect changes in temperature in the wafer 1.

Therefore, based on the temperatures measured by the independent thermocouples 63a to 63e, i.e., the actual temperature of the wafer 1, the temperature controller 61 can immediately perform the feedback control on the heater unit 60.

Similar to the first embodiment, the front sides of the temperature measuring members 65a to 65e face the heater unit 60 in the respective protection sheaths 62a to 62c, allowing the temperature measuring members 65a to 65e to vertically receive radiation heat from the heater unit 60. As a result, the heat treatment apparatus 50 can accurately detect the temperature changes in the wafer 1.

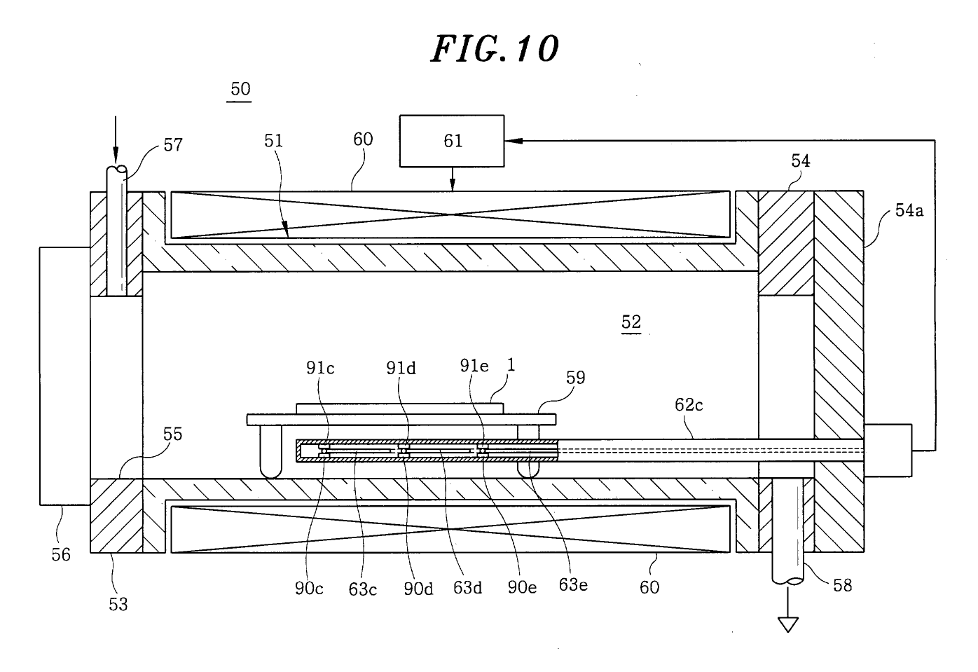

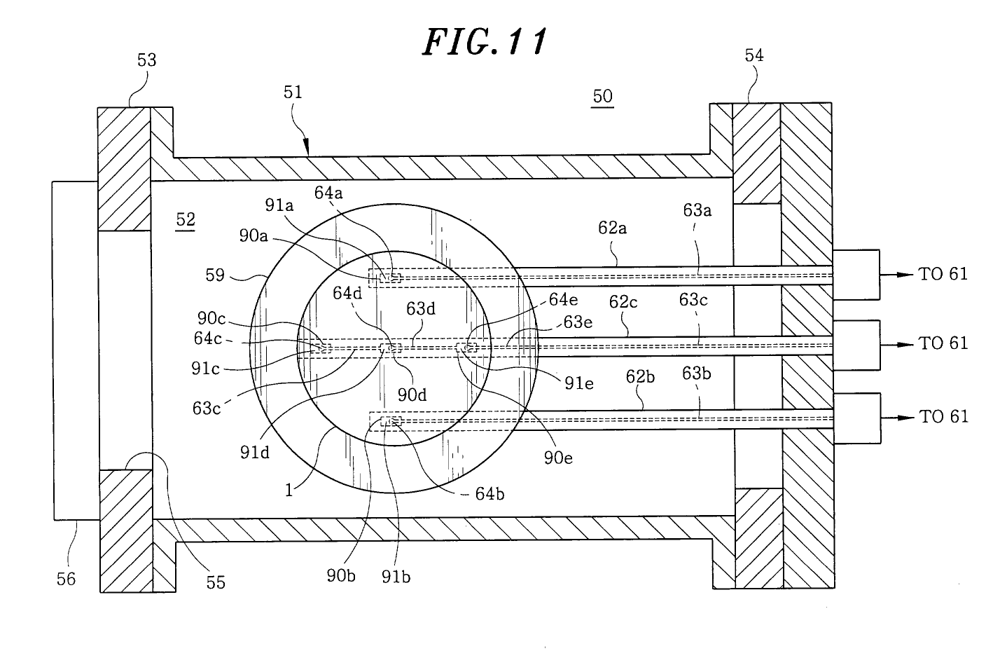

As described above with reference to FIGS. 7A to 9, two temperature measuring members may be employed to be connected to a thermal junction point of one thermocouple by way of interposing the thermal junction point therebetween. There are shown in FIGS. 10 and 11 an alternative of the arrangement of the temperature measuring members 90a to 90e and 91a to 91e and the thermal junction points 64a to 64e in the protection sheaths 62a, 62b, 62c shown in FIGS. 5 and 6.

The temperature measuring members 90a to 90e are installed parallel to the heater unit 60 in a manner of facing the heater unit 60 so that the temperature measuring members 90a to 90e can vertically receive the radiation heat transmitted from the heater unit 60; and further the temperature measuring members 91a to 91e are installed in a manner of facing the wafer 1 positioned opposite to the heater unit 60 so that the temperature measuring member 91a to 91e can receive the radiation heat from the wafer 1. Therefore, the temperature changes in the wafer 1 can be detected with an enhanced accuracy.

The temperature measuring members 90a to 90e and 91a to 91e connected to the thermal junction points 64a to 64e interposed therebetween may be arranged in such a manner that each of the temperature measuring members 90a to 90e and 91a to 91e is substantially parallel to its counterpart temperature measuring member as shown in FIG. 8A. Alternatively, the temperature measuring members 90a to 90e and 91a to 91e can also be bonded to the thermal junction points 64a to 64e in such a manner that each of the temperature measuring members 90a to 90e and 91a to 91e is partially in contact with each other as shown in FIG. 8B.

By controlling the inner temperature of the reaction room 52 as above, the inner temperature thereof is stabilized to a preset process temperature, the process gas is introduced thereinto via the gas inlet passage 57. The process gas introduced into the reaction room 52 propagates and moves down in the reaction room 52 to be discharged via the exhaust passage 58. While the process gas flows in the reaction room 52, it comes in contact with the wafer 1 to carry out the heat treatment on the surface thereof.

After a predetermined time period for performing such a heat treatment has elapsed, a heating operation of the heater unit 60 is stopped by the sequential control of the temperature controller 61, which in turn reduces the inner temperature of the reaction room 52 to a preset standby temperature (e.g., the temperature lower than the process temperature by about 150° C. to 300° C.).

When it reaches the preset standby temperature or the preset drop temperature time period has elapsed, the gate valve 56 opens the furnace inlet opening 55. Thereafter, the wafer 1 is picked up by the wafer transfer system to be unloaded from the displacement table 59 to the outside of the reaction room 52.

The above-explained operations are repeated to apply the single process for the wafer 1 by means of the hot-wall type single substrate heat treatment apparatus 50, to thereby obtain the identical effects of those of the first embodiment.

The invention is not restricted to the preferred embodiments but it is to be understood by those skilled in the art that various changes and modifications may be made without departing from the spirit and scope of the invention.

For instance, it is not necessarily limited to the thermocouples installed close to the wafers disposed in the reaction chamber or the reaction room. It may be provided between the inner tube and the outer tube or between the process tube and the heater unit.

Further, the thermocouples may be inserted into the heater unit by passing therethrough.

The protective sheaths and the support rod may be of a linear shape as well as an L-shape.

In connecting the thermal junction points of the thermocouples with the temperature measuring members, the adhesive method is used, but welding, e.g., a pressure welding method, may be employed.

The heat treatment in accordance with the present invention is discussed to be used in an oxidation process, but it may be applied to a reduction process, a diffusion process, a reflow/annealing process for activating carriers and leveling a surface after the ion implantation, a film formation, and the like.

Though the wafer is processed in the preferred embodiments, the target substrate to be processed is not limited to wafers but may be a photo-mask, a printed circuit board, a liquid crystal panel, an optical disc, a magnetic disc, and the like.

The present invention is applied to the vertical hot-wall type batch heat treatment apparatus and the hot-wall heat treatment apparatus as well as a typical semiconductor device fabricating apparatus and a general heat treatment apparatus such as a horizontal hot-wall type batch heat treatment apparatus or a vertical and horizontal hot-wall type low pressure CVD apparatus and the like.

The present invention can measure the actual temperature of the wafers, resulting in carrying out the appropriate temperature control by using the heater unit.

What is claimed is:

1. A semiconductor device fabricating apparatus, comprising:
a reaction chamber for processing a target substrate;
a temperature measuring member having thermal characteristics identical or substantially identical to those of the target substrate, a maximum outer diameter smaller than that thereof, and a thickness identical or substantially identical to that thereof; and
a thermocouple for measuring an inner temperature of the reaction chamber, the thermocouple having a thermal junction point,
wherein the temperature measuring member is connected to the thermal junction point of the thermocouple.

2. A semiconductor device fabricating apparatus comprising:
a reaction chamber for processing a target substrate;
a temperature measuring member having thermal characteristics identical or substantially identical to those of the target substrate and a maximum outer diameter smaller than that thereof, wherein the temperature measuring member has a first and a second surfaces being opposite to each other;
a thermocouple for measuring an inner temperature of the reaction chamber, the thermocouple having a thermal junction point to which the first surface of the temperature measuring member is connected; and
a heater unit for heating the reaction chamber,
wherein the temperature measuring member is positioned between the heater unit and the target substrate, and the second surface of the temperature measuring member faces the heater unit.

3. A method for fabricating a semiconductor device comprising the steps of:
loading a target substrate into a reaction chamber;
heating the reaction chamber;
measuring an inner temperature of the reaction chamber by using a thermocouple and a temperature measuring member, the temperature measuring member having thermal characteristics identical or substantially identical to those of the target substrate, a maximum outer diameter smaller than that thereof, and a thickness identical or substantially identical to that thereof and the thermocouple having a thermal junction point connected thereto;
controlling the inner temperature of the reaction chamber based on the temperature measurement;
processing the target substrate by supplying process gas into the reaction chamber, to thereby obtain a product substrate;
reducing the inner temperature of the reaction chamber; and
unloading the product substrate from the reaction chamber.
